(19) United States
(12) Patent Application Publication
(10) Pub. No.: US 2025/0301080 A1
(43) Pub. Date: Sep. 25, 2025

(54) DOCUMENT READING APPARATUS THAT DETECTS DOCUMENT SIZE

(71) Applicant: KYOCERA Document Solutions Inc., Osaka (JP)

(72) Inventor: Shinji HAYASHI, Osaka (JP)

(73) Assignee: KYOCERA Document Solutions Inc., Osaka (JP)

(21) Appl. No.: 19/088,411

(22) Filed: Mar. 24, 2025

(30) Foreign Application Priority Data
Mar. 25, 2024 (JP) 2024-048695

(51) Int. Cl. H04N 1/00; H04N 1/028; H04N 1/12

(52) U.S. Cl. CPC H04N 1/00748; H04N 1/00702; H04N 1/00708; H04N 1/00795; H04N 1/02815; H04N 1/1215; H04N 2201/0081

(57) ABSTRACT

A document reading apparatus includes a possible document edge detector that detects, on the basis of a density change indicated by image data acquired by a reading device, a density-changing point, where image density is equal to or higher than a threshold, and most downstream in a transport direction, at each of positions in a main scanning direction, as a possible position of a document edge, and detects an image formed of pixels continuously aligned in the main scanning direction at the possible position, as a possible document edge, and a document size detector that detects a document size in the main scanning direction, on a basis of the image of the possible document edge, when the image of the possible document edge detected by the possible document edge detector is formed of a single image extending in the main scanning direction at a same position in the transport direction.

### INCORPORATION BY REFERENCE

This application claims priority to Japanese Patent Application No. 2024-048695 filed on Mar. 25, 2024, the entire contents of which are incorporated by reference herein.

### BACKGROUND

The present disclosure relates to a document reading apparatus, and in particular to a technique to detect a document size.

Some of existing document reading apparatuses are configured to emit light to a document to detect a shadow formed at the document edge, and detect the document size on the basis of the detected shadow. The document reading apparatus includes an automatic document feeding device that automatically reads the image of the document placed on a document tray, such as a document processor (DP) or an automatic document feeder (ADF).

### SUMMARY

The disclosure proposes further improvement of the foregoing technique.

In an aspect, the disclosure provides a document reading apparatus including a document tray, a transport device, a reading device, a possible document edge detector, and a document size detector. On the document tray, a document is placed. The transport device transports the document placed on the document tray. The reading device includes a light source that emits light to the document being transported by the transport device, and reads an image of the document in a main scanning direction orthogonal to a transport direction, by emitting light to the document being transported by the transport device. The possible document edge detector detects, on a basis of a change in density indicated by image data acquired through a reading operation by the reading device, a position of a density-changing point, where image density is equal to or higher than a predetermined threshold, and most downstream in the transport direction, at each of a plurality of positions in the main scanning direction, as a possible position of a document edge, and further detects an image formed of a pixel group continuously aligned in the main scanning direction at the possible position, as a possible document edge. The document size detector detects a document size of the image data in the main scanning direction, on a basis of the image of the possible document edge, when the image of the possible document edge detected by the possible document edge detector is formed of a single image extending in the main scanning direction at a same position in the transport direction.

### BRIEF DESCRIPTION OF THE DRAWINGS

FIG. 1 is a perspective view showing the appearance of an image forming apparatus, including a document reading apparatus according to a first embodiment of the disclosure;

FIG. 2 is a functional block diagram, schematically showing an essential internal configuration of the image forming apparatus;

FIG. 3A and FIG. 3B are schematic drawings each showing a part of internal configuration of a document feeding device and a document reading device, constituting the document reading apparatus;

FIG. 4 is a functional block diagram, schematically showing an essential internal configuration of the document reading apparatus;

FIG. 5A and FIG. 5B are schematic drawings each showing an example of an image represented by binarized image data;

FIG. 6A is a schematic drawing for explaining a possible position of a document edge;

FIG. 6B and FIG. 6C are schematic drawings for explaining a possible document edge;

FIG. 7 is a schematic drawing for explaining the possible document edge;

FIG. 8 is a flowchart showing an example of an operation performed by a control device of the document reading apparatus;

FIG. 9 is a schematic drawing showing an example of the possible document edge;

FIG. 10A and FIG. 10B are schematic drawings each showing an example of the possible document edge; and

FIG. 11A to FIG. 11C are schematic drawings showing variations of an image, observed when a threshold is lowered in stages.

### DETAILED DESCRIPTION

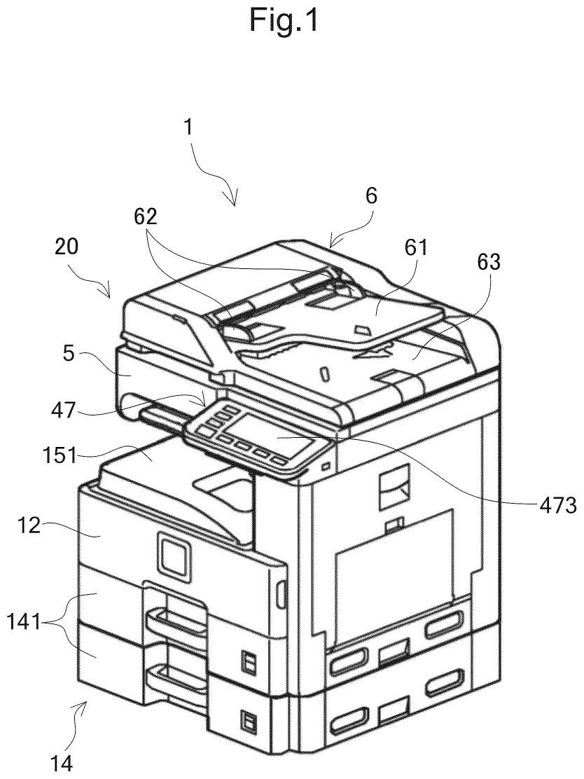

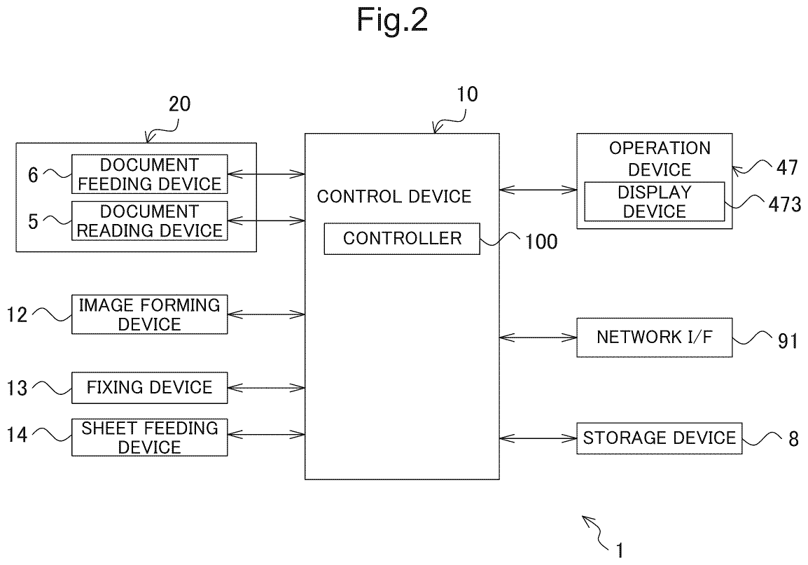

Hereafter, a document reading apparatus according to some embodiments of the disclosure will be described, with reference to the drawings. FIG. 1 is a perspective view showing the appearance of an image forming apparatus, including the document reading apparatus according to a first embodiment of the disclosure. FIG. 2 is a functional block diagram, schematically showing an essential internal configuration of the image forming apparatus. The image forming apparatus 1 is a multifunction peripheral having a plurality of functions, such as copying, printing, scanning, and facsimile transmission, and includes a control device 10, a document feeding device 6, a document reading device 5, an image forming device 12, a sheet feeding device 14, an operation device 47, a network interface (I/F) 91, and a storage device 8. The document reading apparatus 20 is an automatic document feeding device known as DP or ADF, located on the upper side of the main body of the image forming apparatus 1, and includes the document feeding device 6 and the document reading device 5.

The document feeding device 6 is openably connected to the upper face of the document reading device 5, for example via a non-illustrated hinge. The document feeding device 6 serves as a document retention cover, when a document placed on a non-illustrated platen glass is to be read. The document feeding device 6 also includes a document tray 61 on which the document is placed, a pair of document guides 62 provided on the document tray 61, and a document discharge tray 63 provided on the lower side of the document tray 61. The document feeding device 6 feeds the documents placed on the document tray 61 one by one to the document reading device 5, and discharges the document to the document discharge tray 63. The document guides 62 are movable in the width direction of the document, orthogonal to the transport direction thereof, and regulates the position of the document in the width direction.

The document reading device 5 includes a scanner, to read the document delivered from the document feeding device 6, or the document placed on the platen glass. The document reading device 5 can sequentially read a plurality of documents delivered from the document feeding device 6.

To perform the image forming operation, the image forming apparatus 1 operates as follows. The image forming device 12 includes a photoconductor drum, a charging device, an exposure device, a developing device, and a primary transfer device for each of the colors, and forms an image on a recording sheet, serving as a recording medium, by secondary transfer via an intermediate transfer belt. The image forming device 12 forms a toner image on the recording sheet delivered from the sheet feeding device 14, thereby producing a printed material, on the basis of the image data generated through the document reading operation, image data stored in the image memory, or image data received from a computer connected via the network.

The fixing device 13 includes a heat roller, a pressure roller, and a drive mechanism therefor, and heats and presses the recording sheet on which the toner image has been formed by the image forming device 12, at the nip region defined between the mentioned rollers, to thereby fix the toner image onto the recording sheet. The recording sheet that has undergone the fixing process is delivered to an output tray 151.

The sheet feeding device 14 includes a sheet cassette 141, and also includes a pickup roller, transport rollers, a transport route, and rotational drive mechanism for the rollers, to pick up the recording sheet from the sheet cassette 141 and transport the recording sheet to the image forming device 12.

The operation device 47 includes various hard keys to be operated by the user, and receives the user's instructions inputted with the hard keys, to execute the functions and operations that the image forming apparatus 1 is configured to perform, for example the image forming operation.

The operation device 47 includes a display device 473 for displaying, for example, an operation guide for the user. The operation device 47 receives, through a touch panel provided on the display device 473, the user's instruction based on the touch operation performed by the user on the screen displayed on the display device 473.

The display device 473 includes, for example, a liquid crystal display (LCD). When the user touches a button or a key displayed on the screen, the touch panel receives the instruction corresponding to the touched position. In this case, the touch panel acts as a part of the operation device.

The network I/F 91 is a communication interface that transmits and receives various types of data to and from an external device (e.g., a personal computer) located inside the local area, or on the internet.

The storage device 8 is a large-capacity storage device such as a hard disk drive (HDD) and a solid-state drive (SSD), and contains various control programs.

The control device 10 includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The control device 10 includes a controller 100.

The control device 10 acts as the controller 100, when the processor operates according to the control program stored in the storage device 8. Here, the controller 100 may be constituted in the form of a hardware circuit, instead of being realized by the operation of the control device 10 according to the control program. This also applies to other embodiments, unless otherwise specifically noted.

The controller 100 serves to control the overall operation of the image forming apparatus 1. The controller 100 is connected to the document feeding device 6, the document reading device 5, the image forming device 12, the fixing device 13, the sheet feeding device 14, the operation device 47, the network I/F 91, and the storage device 8, and controls the operation of the mentioned components. For example, the controller 100 executes some processings required for the image forming operation to be performed by the image forming apparatus 1. As another example, the controller 100 controls the operation of the image forming device 12, to execute a copy job including forming, on the recording medium, the image represented by the image data acquired through the reading operation by the document reading device 5.

To perform the document reading operation, the image forming apparatus 1 operates as follows. The document reading device 5 optically reads the image on the document delivered from the document feeding device 6 to the document reading device 5, or placed on the platen glass, and generates image data. The image data generated by the document reading device 5 is stored, for example, in a non-illustrated image memory.

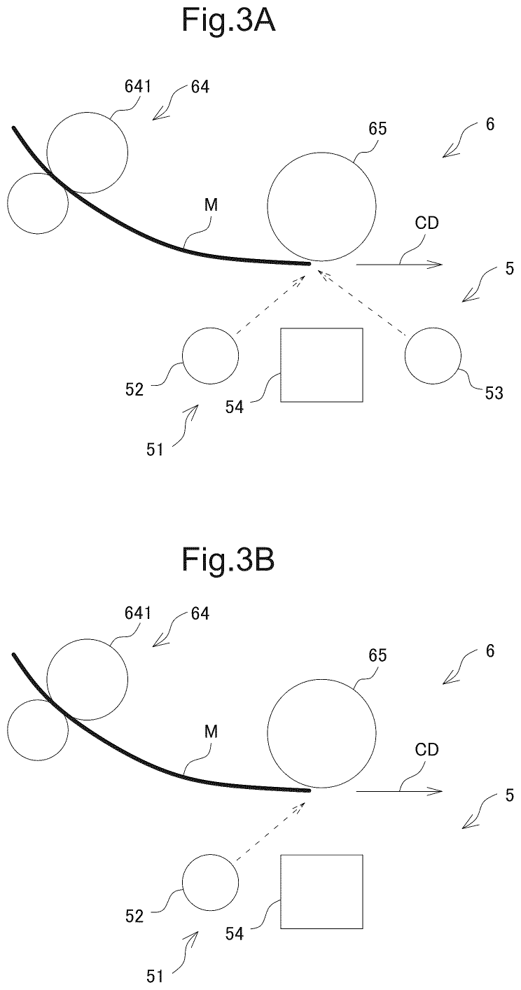

FIGS. 3A and 3B are schematic drawings each showing a part of the internal configuration of the document feeding device 6 and the document reading device 5, constituting the document reading apparatus 20. FIG. 3A illustrates the configuration of a high-speed device, and FIG. 3B illustrates the configuration of a low- and middle-speed device.

The document feeding device 6 includes a transport device 64 that transports the document M placed on the document tray 61 (see FIG. 1), and a shading roller 65. The document reading device 5 includes a reading device 51, having light sources 52 and 53 that each emit light (indicated by broken lines) to the document M being transported by the transport device 64, and a reading sensor 54. The low- and middle-speed device includes a fewer number of light sources, than the high-speed device.

The transport device 64 includes a transport roller pair 641 and a non-illustrated discharge roller pair. The transport roller pair 641 serves to transport the document M placed on the document tray 61, so as to guide the document M to the position between the shading roller 65 and the reading sensor 54 (image reading position). After passing the image reading position, the document M is discharged to the document discharge tray 63 (see FIG. 1), through a non-illustrated discharge roller.

The reading device 51 includes the light sources 52 and 53 that each emit light to the document M being transported by the transport roller pair 641, and reads the image of the document M with the reading sensor 54, in the main scanning direction SD (direction from the near side to the deeper side in FIG. 3), orthogonal to the transport direction CD of the document M. The light sources 52 and 53 are, for example, each constituted of an LED, and extend in the main scanning direction SD. The reading sensor 54 is, for example, a contact image sensor (CIS), and extends in the main scanning direction SD.

The light source 52 illuminates the document M passing the image reading position, in a direction obliquely intersecting the transport direction CD, from the upstream side to the downstream side in the transport direction CD. In contrast, the light source 53 illuminates the document M passing the image reading position, in a direction obliquely intersecting the transport direction CD, from the downstream side to the upstream side in the transport direction CD. Here, when the light sources are provided on both of the upstream side and the downstream side as shown in FIG. 3A, the shadow of the document edge becomes difficult to be recognized. Therefore, the ratio of light amount between the light sources 52, and 53 is adjusted such that the light amount of the light source 53 on the downstream side becomes approximately 70% of the light source 52 on the upstream side, to make is easier to recognize the shadow of the document edge.

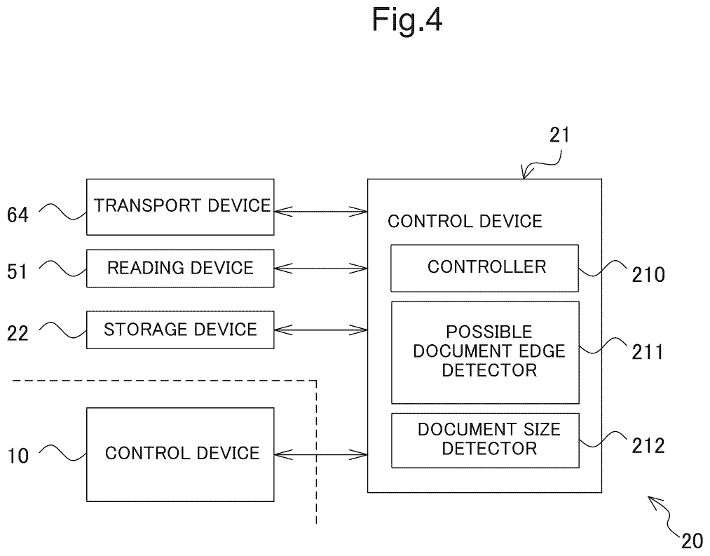

FIG. 4 is a functional block diagram, schematically showing an essential internal configuration of the document reading apparatus 20. The document reading apparatus 20 includes a control device 21, a transport device 64, a reading device 51, and a storage device 22. The control device 21 includes a processor, a RAM, a ROM, and an exclusive hardware circuit. The processor is, for example, a CPU, an ASIC, or an MPU. The control device 21 includes a controller 210, a possible document edge detector 211, and a document size detector 212.

The control device 21 acts as the controller 210, the possible document edge detector 211, and the document size detector 212, when the processor operates according to the control program stored in the storage device 22, for example including a non-volatile memory. Here, although the document reading apparatus 20 includes the control device 21 in this embodiment, the document reading apparatus 20 may be without the control device 21, and instead the control device 10 of the image forming apparatus 1 may be configured to also act as the control device 21. In this case, the document reading apparatus 20 includes, as a part thereof, the controller 210, the possible document edge detector 211, and the document size detector 212 realized by the control device 10 of the image forming apparatus 1.

The controller 210 serves to control the overall operation of the document reading apparatus 20. The controller 210 is connected to the transport device 64, the reading device 51, and the storage device 22, and controls the operation of these components. For example, the controller 210 acquires the image data of the document M, and outputs the acquired image data to the control device 10 in the main body of the image forming apparatus 1. In addition, the controller 210 outputs the data indicating the document size (in the main scanning direction and transport direction) and the skew of the document M, delivered from the document tray 61, to the image forming apparatus 1.

The possible document edge detector 211 detects, on the basis of a change in density indicated by the image data acquired through the reading operation by the reading device 51, a position of a density-changing point, where image density is equal to or higher than a predetermined threshold TH, and most downstream in the transport direction CD, at each of a plurality of positions in the main scanning direction SD, as a possible position of a document edge, and further detects an image formed of a pixel group continuously aligned in the main scanning direction SD at the possible position, as a possible document edge. When the document M is read by the reading device 51, the image is read at the positions along the transport direction CD of the document M, by the scanning line of the reading sensor 54 extending in the main scanning direction SD, and the image data acquired by reading the document M is generated, in which images im1, read by the scanning line of the reading sensor 54 at the respective positions, are aligned in the transport direction CD. The main scanning direction SD in the image data refers to the direction in which the image im1, acquired by one reading operation of the scanning line, is extending, and the transport direction CD in the image data refers to the direction orthogonal to the direction in which the images im1 are aligned.

The document size detector 212 detects the document size of the image data in the main scanning direction SD, on the basis of the image of the possible document edge, when the image of the possible document edge detected by the possible document edge detector 211 is formed of a single image extending in the main scanning direction SD, at the same position in the transport direction CD.

In addition, the document size detector 212 detects the document size of the document M in the transport direction CD, on the basis of a signal from a non-illustrated optical sensor that detects the passing of the leading edge and the trailing edge of the document being transported, from the time after the leading edge of the document has passed and until the trailing edge of the document has passed, and the transport speed of the document M.

Hereunder, an operation of the document reading apparatus 20 for detecting the document size in the main scanning direction SD will be described. It is density information (brightness information) of the image, that is required to detect an image of a shadow formed at the document edge in the transport direction CD, in the image data acquired through the reading operation by the document reading device 5. Accordingly, the possible document edge detector 211 executes an image processing operation such as binarization, with respect to the image data acquired by the reading device 51, to clarify the boundary between the shadow formed at the document edge (dark portion) and the background (bright portion).

For example, when the image represented by the image data acquired by the reading device 51 is a color image (RGB), the possible document edge detector 211 performs YUV conversion with respect to the image data, thereby forming a single-color image. The possible document edge detector 211 performs filtering, for example using a Sobel filter, with respect to the single-color image, to reduce noise and emphasize the edge, and then binarizes the image on the basis of a predetermined threshold TH. When the threshold TH is too high, the shadow of the document edge becomes unable to be detected, and when the threshold TH is too low, noise is also detected. Therefore, the appropriate value of the threshold TH is determined in advance, through experiments. For example, the threshold TH may be set to 32, with respect to the pixel value 0 to 255 (8 bit) that the single-color image can represent. Here, it is preferable that the possible document edge detector 211 performs dilation and erosion process with respect to the binarized image data, to increase the continuity of the image of the shadow of the document edge, thereby preventing the image representing the shadow of the document edge from being split, along the main scanning direction SD.

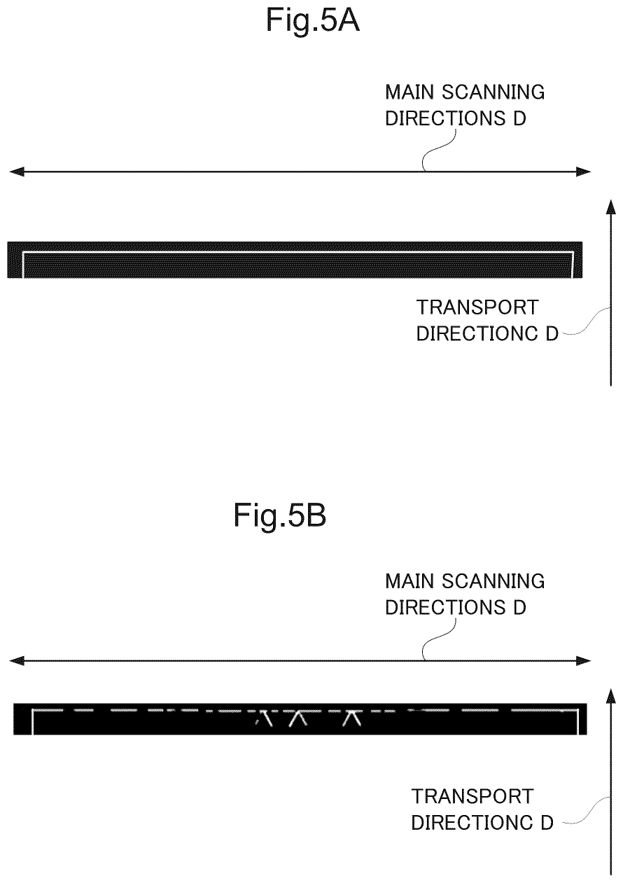

FIGS. 5A and 5B are schematic drawings each showing an example of the image represented by the image data formed through the binarization of the image data acquired by the reading device 51. The black portion in the image shown in FIGS. 5A and 5B represents the portion where the density is lower than the threshold TH, and the white portion represents the portion where the density is equal to or higher than the threshold TH, and showing the shadow of the document edge. In the image shown in FIG. 5A, the shadow of the document edge can be clearly seen, but in the image shown in FIG. 5B, the image showing the shadow of the document edge is split at some positions along the main scanning direction SD.

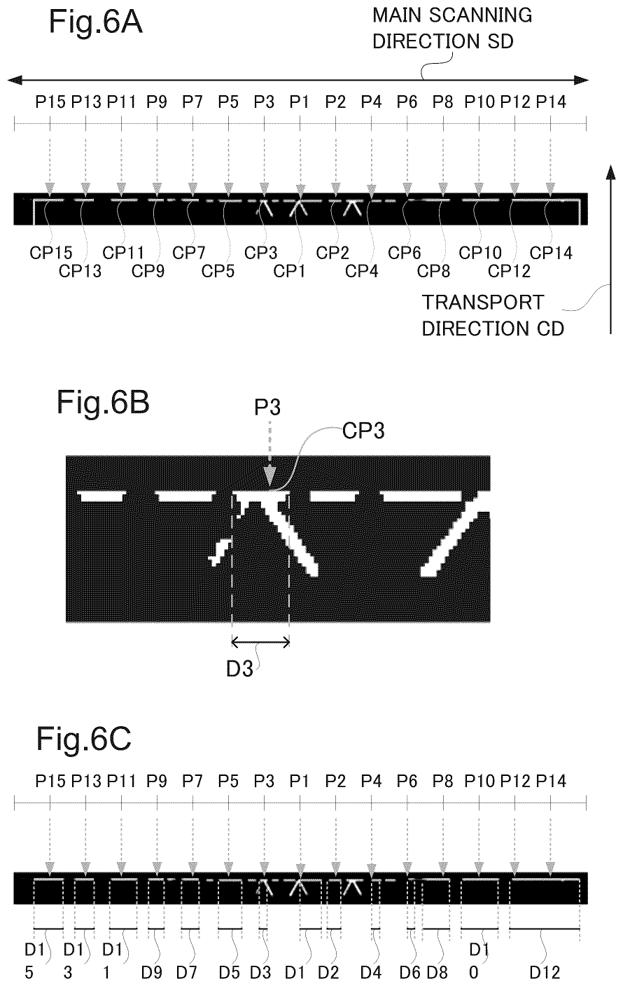

The possible document edge detector 211 detects the possible document edge, with respect to the image shown in FIG. 5B. More specifically, as shown in FIG. 6A, the possible document edge detector 211 detects positions CP1 to CP15 of a density-changing point (point where the image changes from black to white), where the image density is equal to or higher than the threshold TH, and most downstream in the transport direction CD, at each of a plurality of positions P1 to P15 dividing the image reading range of the reading device 51 into 16 portions in the main scanning direction SD, as the possible position of the document edge.

Further, the possible document edge detector 211 detects the image formed of a pixel group continuously aligned in the main scanning direction SD, at each of the possible positions CP1 to CP15, as the possible document edge. As the example shown in FIG. 6B, at the possible position CP3 of the document edge, the possible document edge detector 211 detects the image formed of the pixel group continuously aligned at the possible position CP3 in the main scanning direction SD, and having a length D3, as the possible document edge.

FIG. 6C shows the possible document edge detected at each of the possible positions CP1 to CP15 of the document edge, and the lengths D1 to D15 (except for the length D14) of the respective possible document edges. As shown in FIG. 6C, at the possible positions CP12 and CP14 of the document edge, the same (single) possible document edge is detected, which has a length D12. Here, the possible document edge detector 211 excludes a line segment shorter than a predetermined size (e.g., 20 mm) from the possible document edge. This arrangement prevents, for example, a small piece of dust from being included in the possible document edge.

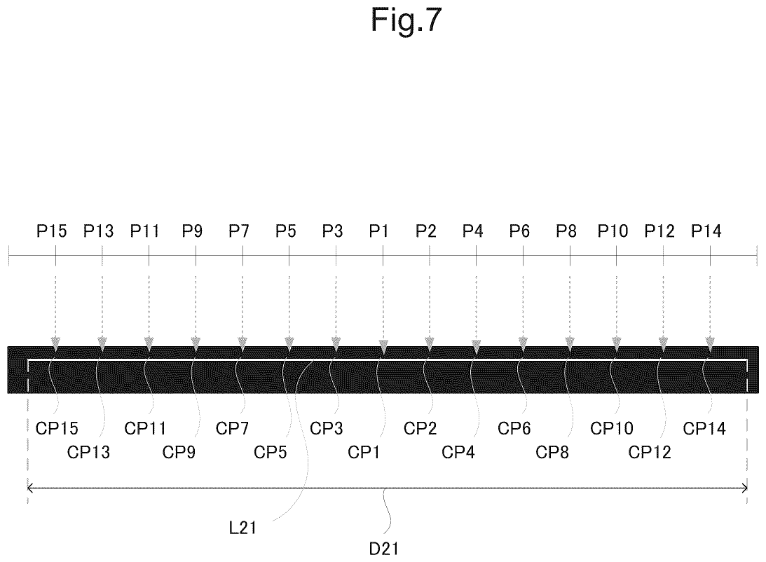

In the case where, as shown in FIG. 7, the image representing the shadow of the document edge is not divided in the main scanning direction SD, the same (single) possible document edge, in other words the possible document edge formed of the single image extending in the main scanning direction SD, is detected along the possible positions CP1 to CP15 of the document edge, and the length of such image is D21.

In this case, the document size in the main scanning direction SD can be accurately calculated, on the basis of the positions (coordinates of the positions) of the respective ends of the possible document edge L21 in the main scanning direction SD. However, when a plurality of images of the possible document edge, detected by the possible document edge detector 211, are aligned in the main scanning direction SD, in other words the image representing the shadow of the document edge is split at some positions along the main scanning direction SD (see FIG. 6A), it is difficult to accurately detect the length of the image data in the main scanning direction SD, on the basis of the length of each of the possible document edges in the main scanning direction SD.

Therefore, when the image of the possible document edge, detected by the possible document edge detector 211, is formed of a single image extending in the main scanning direction SD, at the same position in the transport direction CD, the document size detector 212 detects the document size in the main scanning direction SD, of the image data acquired through the document reading operation, on the basis of the image of such possible document edge.

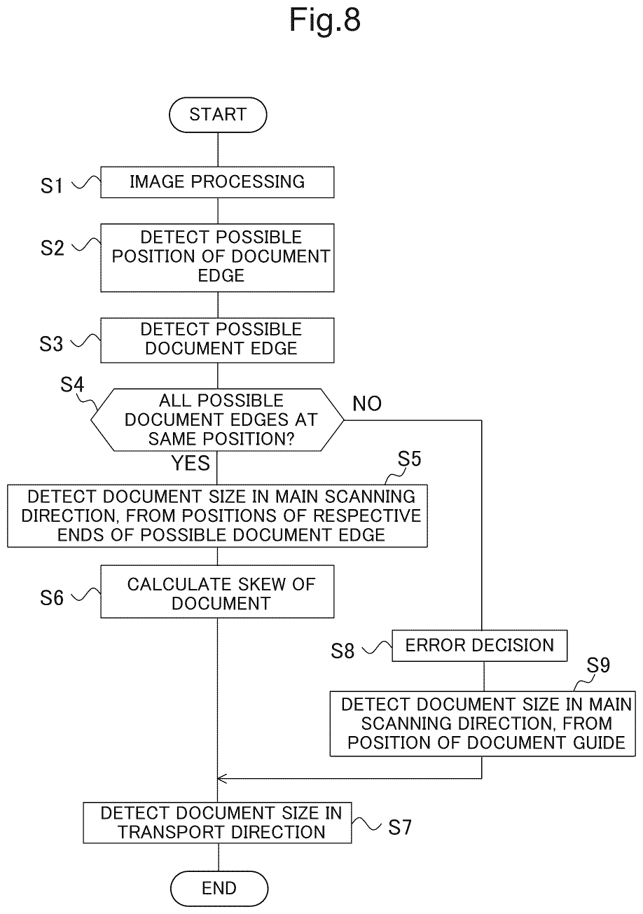

Referring now to a flowchart shown in FIG. 8, an operation of the document reading apparatus 20, performed to detect the document size in the main scanning direction SD, will be described hereunder.

The possible document edge detector 211 executes the image processing, such as the binarization, with respect to the image data acquired through the reading operation by the reading device 51 (S1), detects the density-changing point, where the density is equal to or higher than the threshold TH, and most downstream in the transport direction CD, at each of the plurality of positions P1 to P15, as the possible position of the document edge (S2), and detects the image formed of the pixel group continuously aligned in the main scanning direction SD, at the possible position, as the possible document edge (S3).

Then the document size detector 212 decides whether the image of the possible document edge detected by the possible document edge detector 211 is formed of a single image extending in the main scanning direction SD, at the same position in the transport direction CD (S4). Upon deciding that the image of the possible document edge detected by the possible document edge detector 211 is continuous along the main scanning direction SD at the same position in the transport direction CD (see FIG. 7), thus being formed of a single image extending in the main scanning direction SD (YES at S4), the document size detector 212 detects, on the basis of the positions (coordinates of the positions) of the respective ends of the image of the possible document edge in the main scanning direction SD, the length between one end and the other end, as the document size in the main scanning direction SD (S5). Further, the document size detector 212 calculates the skew of the document M, on the basis of the positions of the respective ends of the possible document edge in the transport direction CD (S6). Still further, the document size detector 212 detects the document size of the document M in the transport direction CD, on the basis of the signal from the optical sensor that detects the passing of the leading edge and the trailing edge of the document being transported, from the time after the leading edge of the document has passed and until the trailing edge of the document has passed, and the transport speed of the document M (S7). At this point, the document size detection process is finished. The data indicating the document size in the main scanning direction SD and the transport direction CD, and the skew of the document M, is outputted by the controller 210 to the control device 10.

However, when the document size detector 212 decides that the image of the possible document edge detected by the possible document edge detector 211 is not continuous but split along the main scanning direction SD, at the same position in the transport direction CD, and not formed of a single image extending in the main scanning direction SD (NO at S4), the document size detector 212 decides that an error has occurred in the detection of the document size (S8). In this case, the document size detector 212 detects the document size in the main scanning direction SD, on the basis of a signal from a non-illustrated optical sensor that detects the position of the document guide 62, moved according to the position of the edges in the main scanning direction SD, of the document M placed on the document tray 61 (S9). After S9, the operation of S7 is performed, in other words the document size in the transport direction CD is detected, and the document size detection process is finished. The data indicating the document size in the main scanning direction SD and the transport direction CD is outputted by the controller 210 to the control device 10.

According to the first embodiment, the document size in the main scanning direction is detected on the basis of the image of the possible document edge, when the image of the possible document edge is formed of a single image extending in the main scanning direction at the same position in the transport direction CD. In other words, the document size is detected only when accurate detection of the document size can be performed, and therefore the accuracy in detection can be secured. In the case where the image of the possible document edge is not formed of a single image extending in the main scanning direction, the detection of the document size in the main scanning direction, based on the image of the possible document edge, is not performed. Therefore, inaccurate detection of the document size, which leads to an output of an improper image, can be prevented.

Hereunder, a second embodiment of the operation of the document reading apparatus 20, performed to detect the document size in the main scanning direction SD, will be described. The second embodiment is different from the first embodiment, in that the document size in the main scanning direction SD is detected on the basis of the possible document edge, despite the image of the possible document edge not being formed of a single image extending in the main scanning direction.

In the second embodiment, when the image of the possible document edge is not formed of a single image extending in the main scanning direction SD, but formed of a plurality of images aligned along the main scanning direction SD, and located at the same position in the transport direction CD, the document size detector 212 detects the document size in the main scanning direction SD, on the basis of the image of the possible document edge closest to one end in the main scanning direction SD, and the image of the possible document edge closest to the other end.

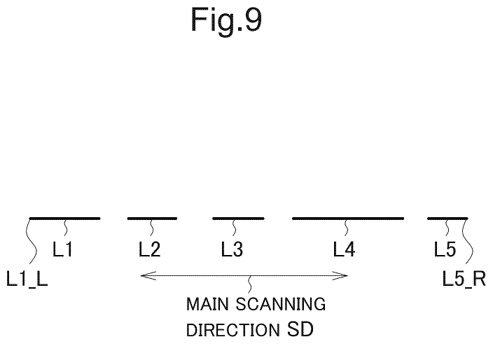

For example, when the possible document edges L1 to L5 are aligned in the main scanning direction SD as shown in FIG. 9, the possible document edge located closest to one end (on the left in FIG. 9) in the main scanning direction SD, among the possible document edges L1 to L5, is the possible document edge L1, and the possible document edge closest to the other end is the possible document edge L5. In this case, the document size detector 212 detects the respective outer ends L1_L and L5_R of the possible document edges L1 and L5, and detects the length between the position L1_L and the position L5_R, as the document size in the main scanning direction SD.

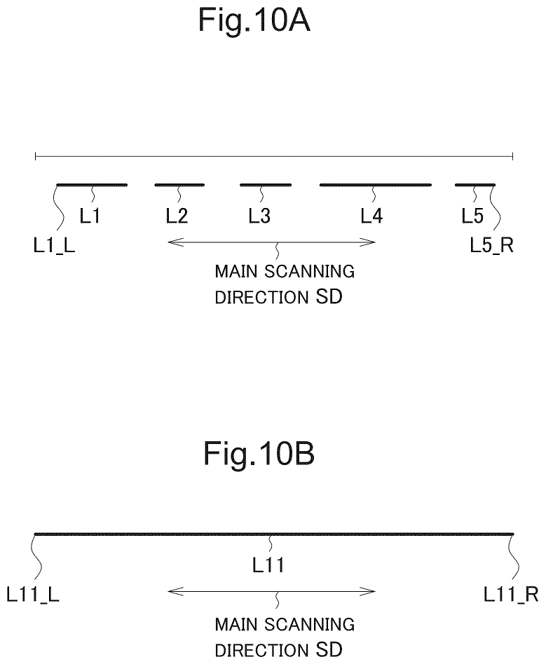

Hereunder, a third embodiment of the operation of the document reading apparatus 20, performed to detect the document size in the main scanning direction SD, will be described. The third embodiment is different from the first embodiment in that, when the image showing the shadow of the document edge is split at some positions along the main scanning direction SD, as shown in FIG. 10A, the possible document edge detector 211 changes the predetermined threshold TH to a lower value, to facilitate the image showing the document edge to appear.

When the image of the possible document edge is not formed of a single image extending in the main scanning direction SD, but formed of a plurality of images aligned along the main scanning direction SD, and located at the same position in the transport direction CD, the document size detector 212 stores the longest one in the main scanning direction SD, among the possible document edges, in a memory as a document edge reference line. The possible document edge detector 211 lowers the threshold TH, until the image of the possible document edge is detected as a single image extending in the main scanning direction SD, at the same position in the transport direction CD. Then the document size detector 212 detects the document size in the main scanning direction SD, on the basis of the image of the possible document edge formed of the single image, the position of which in the transport direction CD falls on the position of the document edge reference line stored in the memory.

Here, the document size detector 212 may calculate a straight line component of the possible document edge by linear interpolation, on the basis of the coordinate positions of the respective ends of the possible document edge designated as the document edge reference line, and detect the document size in the main scanning direction SD on the basis of the image of the possible document edge formed of the single image, having the same straight line component as the straight line component calculated as above.

When the possible document edges L1 to L5 are aligned as shown in FIG. 10A, the possible document edge detector 211 memorizes the possible document edge L4. Longest among L1 to L5, as the document edge reference line, and lowers the threshold TH, until the possible document edge L1 to L5 are all connected, at the position in the transport direction CD that falls on the position of the document edge reference line, as shown in FIG. 10B, thereby detecting a possible document edge L11.

The possible document edge detector 211 lowers the threshold TH in stages, for example as follows. When the initial value is 32 for example, the threshold TH is lowered by 8 stages, to 24. If the possible document edges are not connected yet with such change, the threshold TH is lowered by another 8 stages, to 16. However, when the possible document edges are not connected, despite the threshold TH having been lowered to a predetermined lower limit, the possible document edge detector 211 stops changing the threshold TH.

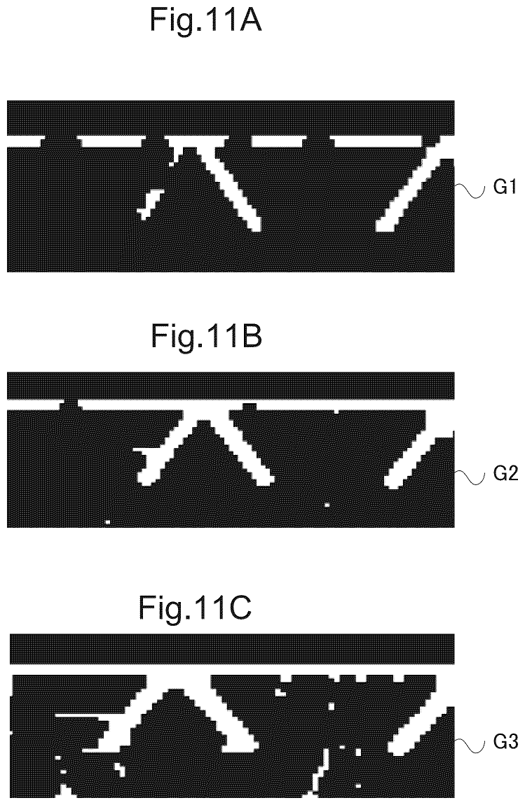

FIGS. 11A to 11C each illustrate an example of the image, obtained by lowering the threshold TH in stages. In an image G1 shown in FIG. 11A, the possible document edge (shadow of the document edge) is split in the main scanning direction SD. In an image G2 shown in FIG. 11B, the possible document edge is partially connected in the main scanning direction SD. In an image G3 shown in FIG. 11C, the possible document edges are all connected in the main scanning direction SD. The possible document edge detector 211 lowers the threshold TH in stages, for example until the image G1 shown in FIG. 11A turns into the image G3 shown in FIG. 11C.

When the possible document edge L11 shown in FIG. 10B is obtained as result of the mentioned adjustment of the threshold TH, the document size detector 212 detects the document size, on the basis of the positions of the respective ends L11_L and L11_R of the possible document edge L11.

With the increasing demand for improvement in productivity, the automatic document feeding device is required to read the image of the document at a high speed. To read the image of the document at a high speed, a larger amount of light has to be emitted to the document, compared with the case of low- or middle-speed reading. However, when the amount of light emitted to the document is increased, the image of the shadow created by emitting light to the document edge, included in the image acquired through the reading operation, becomes vague. In particular, when the sheet of the document is thin, the shadow becomes less likely to be created at the document edge, and the image becomes vague. In such a case, the document size is unable to be accurately detected, and the outputted image may differ from the actual document size. However, with the arrangement according to the foregoing embodiments, the accuracy in detection of the document size can be secured.

The disclosure may be modified in various manners, without limitation to the configuration according to the foregoing embodiments. Further, the configurations and processings described in the embodiments with reference to FIG. 1 to FIG. 11 are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is:

1. A document reading apparatus comprising:
a document tray on which a document is placed;
a transport device that transports the document placed on the document tray;
a reading device including a light source that emits light to the document being transported by the transport device, and configured to read an image of the document in a main scanning direction orthogonal to a transport direction, by emitting light to the document being transported by the transport device;
a possible document edge detector that detects, on a basis of a change in density indicated by image data acquired through a reading operation by the reading device, a position of a density-changing point, where image density is equal to or higher than a predetermined threshold, and most downstream in the transport direction, at each of a plurality of positions in the main scanning direction, as a possible position of a document edge, and further detects an image formed of a pixel group continuously aligned in the main scanning direction at the possible position, as a possible document edge; and
a document size detector that detects a document size of the image data in the main scanning direction, on a basis of the image of the possible document edge, when the image of the possible document edge detected by the possible document edge detector is formed of a single image extending in the main scanning direction at a same position in the transport direction.

2. The document reading apparatus according to claim 1,
wherein, when the image of the possible document edge is formed of a plurality of images, located at a same position in the transport direction, and extending in the main scanning direction, the document size detector detects the document size in the main scanning direction, on a basis of the image of the possible document edge closest to one end in the main scanning direction, and the image of the possible document edge closest to the other end.

3. The document reading apparatus according to claim 1,
wherein, when the image of the possible document edge is formed of a plurality of images extending in the main scanning direction, the possible document edge detector memorizes an image longest in the main scanning direction among the plurality of images of the possible document edge, as a document edge reference line, and changes the threshold to a lower value, until the image of the possible document edge is detected as a single image extending in the main scanning direction, at a same position in the transport direction, and
the document size detector detects the document size in the main scanning direction, on a basis of the image of the possible document edge formed of the single image, the position of which in the transport direction falls on the position of the document edge reference line.

4. The document reading apparatus according to claim 3,
wherein the document size detector calculates a straight line component of the possible document edge by linear interpolation, on a basis of coordinate positions of respective ends of the possible document edge designated as the document edge reference line, and detects the document size in the main scanning direction, on a basis of the image of the possible document edge formed of the single image, having a same straight line component as the straight line component calculated.
